(19) United States
(12) Patent Application Publication
(10) Pub. No.: US 2019/0176987 A1
(43) Pub. Date: Jun. 13, 2019

(54) SYSTEM AND METHOD FOR FIRE SUPPRESSION VIA ARTIFICIAL INTELLIGENCE

(71) Applicant: James E. Beecham, West Palm Beach, FL (US)

(72) Inventor: James E. Beecham, West Palm Beach, FL (US)

(21) Appl. No.: 15/967,534

(22) Filed: Apr. 30, 2018

Related U.S. Application Data
(60) Provisional application No. 62/708,563, filed on Dec. 13, 2017.
(60) Provisional application No. 62/708,617, filed on Dec. 16, 2017.
(60) Provisional application No. 62/708,858, filed on Dec. 26, 2017.
(60) Provisional application No. 62/708,890, filed on Dec. 27, 2017.
(60) Provisional application No. 62/708,980, filed on Dec. 29, 2017.
(60) Provisional application No. 62/708,992, filed on Dec. 29, 2017.
(60) Provisional application No. 62/709,014, filed on Jan. 2, 2018.
(60) Provisional application No. 62/709,021, filed on Jan. 2, 2018.
(60) Provisional application No. 62/657,879, filed on Apr. 15, 2018.
(60) Provisional application No. 62/662,839, filed on Apr. 26, 2018.
(60) Provisional application No. 62/663,646, filed on Apr. 27, 2018.
(60) Provisional application No. 62/664,145, filed on Apr. 28, 2018.
(60) Provisional application No. 62/664,167, filed on Apr. 29, 2018.
(60) Provisional application No. 62/664,289, filed on Apr. 30, 2018.

(51) Int. Cl. B64D 1/16; B64C 39/02; A62C 3/02; G06F 15/18; G08B 17/00

(52) U.S. Cl. CPC B64D 1/16; B64C 39/024; A62C 3/0242; A62C 3/0257; B64C 2201/148; G08B 17/005; B64C 2201/12; B64C 2201/141; G06F 15/18

(57) ABSTRACT

A system and method for fire suppression via artificial intelligence having an artificial intelligence (Al) enabled computer command system connected to a network defining a community. The AI enabled computer connected to a plurality of sensors in the community, both stationary and mobile. The sensors communicate data to the system, indicating possible wildfire activity. The system via machine learning and AI techniques dispatches drones with fire suppression technology to locations where wildfire activity is present. The system further provides a method for predicting wildfire spreading locations, as well as a method for suppressing spot fires and protecting homes downwind from a wildfire.

### CROSS-REFERENCE TO RELATED APPLICATIONS

The present application claims priority to U.S. Provisional Application Ser. No. 62/708,563 filed on Dec. 13, 2017 entitled “Fire Suppression via Artificial Intelligence”, U.S. Provisional Application Ser. No. 62/708,617 filed on Dec. 16, 2017 entitled “Fire Insurance Cloud Computing”, U.S. Provisional Application Ser. No. 62/708,858 filed on Dec. 26, 2017 entitled “Rapidly reusable roof Fire-Blanket”, U.S. Provisional Application Ser. No. 62/708,890 filed on Dec. 27, 2017 entitled “Low-frequency Sound Fire-Protection”, U.S. Provisional Application Ser. No. 62/708,980 filed on Dec. 29, 2017 entitled “Behavioral Artificial intelligence for Fire-Fighting”, U.S. Provisional Application Ser. No. 62/708,992 filed on Dec. 29, 2017 entitled “Fire-fighting against ‘Torch-trees’”, U.S. Provisional Application Ser. No. 62/709,014 filed on Jan. 2, 2018 entitled “Machine learning for extinguishing of flames”, U.S. Provisional Application Ser. No. 62/709,021 filed on Jan. 2, 2018 entitled “Community Fire-Spotting Method and System”, U.S. Provisional Application Ser. No. 62/703,035 filed on Jan. 3, 2018 entitled “Fire-Blanket-on-Tree Fire Break”, U.S. Provisional Application Ser. No. 62/657,879 filed on Apr. 15, 2018 entitled “Unmanned aerial vehicle with tether for fire-fighting”, U.S. Provisional Application Ser. No. 62/662,893 filed on Apr. 26, 2018 entitled “Machine learning method and system to protect community from wildfire”, U.S. Provisional Application Ser. No. 62/663,646 filed on Apr. 27, 2018 entitled “Method and system for algorithm adjustment for improved-fire protection”, and U.S. Provisional Application Ser. No. 62/664,145 filed on Apr. 30, 2018 entitled “Method and system for Fire-suppression of spot-fires near to home comprising use of artificial intelligence”, U.S. Provisional Application Ser. No. 62/664,167 filed on Apr. 30, 2018 entitled “Method and system to coordinate protection of community of unoccupied homes after passage of wildfire front”, and U.S. Provisional Application Ser. No. 62/664,289 filed on Apr. 30, 2018 entitled “Method and system to for home-specific fire-risk rating and protection from wildfire” the disclosures of which are hereby incorporated in their entirety at least by reference.

### BACKGROUND OF THE INVENTION

### 1. Field of the Invention

The present invention generally relates to fire suppression, and more particularly to a system and method for fire suppression via artificial intelligence.

### 2. Description of Related Art

Wildfires, such as those affecting dried brush-lands and hillsides and nearby communities, continue to cause loss of life and major destruction, such as to burned homes and lands in California. Such fires may spread even more quickly where winds push embers to ignite dry kindling or treetops many yards away from the earlier leading edge of the fire. In these conditions, fire fighters have difficulty containing such a rapidly spreading fire. Funds to pay for new or improved means to fight a fire or plan/prepare for preventing future damage are often not available. What is needed is a better means to prevent the destruction from outdoor fires.

“Fire detection systems and methods” U.S. Pat. No. 5,832,187A, “Fire detection systems using artificial intelligence” U.S. Pat. No. 6,289,331B1, and “Fire detection systems and methods” U.S. Pat. No. 6,556,981B2 all to Pedersen et al, disclose various systems and methods of fire detection using artificial intelligence, such as a drone or piloted aircraft. However, the artificial intelligence is not used to put out fire. Further, the system and method is not used in planning, survey, or the practice of fi refighting.

### BRIEF SUMMARY OF THE INVENTION

In one embodiment of the present invention a method for fire suppression via artificial intelligence is provided, comprising steps (a) collecting, via one or more sensors, a first dataset from a first location; (b) analyzing, via an artificial intelligence enabled computer command system, the first dataset from the first location at a first time; (c) identifying, via the artificial intelligence enabled computer command system, the first location as having a likely wildfire when the analysis at the first time sufficiently via an algorithm matches data in a data repository representative of an active wildfire; (d) dispatching, via the artificial intelligence enabled computer command system, a fire suppression drone having onboard sensors and a reservoir configured to release a fire suppression substance to the first location at a second time; (e) releasing, via the artificial intelligence enabled computer command system, the fire suppression substance on the likely wildfire; (e) collecting, via the onboard sensors, a second dataset from the first location; (f) analyzing, via the artificial intelligence enabled computer command system, the second dataset at a third time; and, (g) identifying, via the artificial intelligence enabled computer command system, the first location as having at least a partially suppressed wildfire when the analysis at the third time sufficiently via the algorithm matches data in the data repository representative of a partially suppressed wildfire.

In one embodiment, the one or more sensors are provided on one or more fire sensor poles. In one embodiment, the one or more fire sensor poles are positioned stationary in predetermined locations in a community. In another embodiment, the one or more fire sensor poles are positioned on one or more autonomous vehicles. In one embodiment, a further step (h) is provided, wherein the fire suppression drone travels to a reservoir refilling source to refill the reservoir. In one embodiment, a further step is provided, wherein steps (d)-(h) are repeated until the partially suppressed wildfire is extinguished. In yet another embodiment, the artificial intelligence enabled computer command system and the one or more sensors are connected to a metropolitan area network. In one embodiment, the fire suppression drone is an unmanned aerial vehicle. In another embodiment, a further step is provided, wherein the unmanned aerial vehicle is tethered to a ground surface in high wind conditions.

In another aspect of the invention, a method for fire suppression via artificial intelligence is provided, comprising steps (a) assessing a wildfire via an artificial intelligence algorithm; (b) providing a set of fire-fighting instructions; (c) executing the set of fire-fighting instructions, wherein the set of fire-fighting instructions comprises unmanned aerial vehicle enabled fire suppression techniques.

In one embodiment, the unmanned aerial vehicle enabled fire suppression techniques include a fire suppression substance released on the wildfire. In one embodiment, the unmanned aerial vehicle enabled fire suppression techniques include tethering the unmanned aerial vehicle to a ground surface in high wind conditions. In one embodiment, the unmanned aerial vehicle enabled fire suppression techniques include a fire suppression substance released on a spot fire spread from the wildfire. In another embodiment, the unmanned aerial vehicle enabled fire suppression techniques include a fire suppression blanket released on homes adjacent to the spot fire.

In yet another aspect of the invention, a system for fire suppression via artificial intelligence is provided, comprising an artificial intelligence enabled computer command system including an Internet connected server connected to a data repository configured to run machine learning applications, wherein the Internet connected server is connected to a metropolitan area network defining a community; a plurality of fire sensor poles positioned at predetermined locations in the community, wherein the plurality of fire sensor poles include sensors configured to gather wind speed and direction data, and temperature data, wherein the sensors are connected to the metropolitan area network; a first plurality of fire suppression drones, each drone of the first plurality of fire suppression drones comprising a reservoir configured to store a fire-suppression substance, a nozzle configured to release the fire-suppression substance, and an Internet enabled wireless antenna in communication with metropolitan area network; a plurality of fire-suppression substance refill stations configured to resupply the reservoir of each drone of the first plurality of fire suppression drones with the fire-suppression substance via a pump and a supply line; and, a second plurality of fire suppression drones, each drone of the second plurality of fire suppression drones comprising a fire suppression blanket provided on a reel.

In one embodiment, the plurality of fire sensor poles is both stationary and mobile, and wherein the mobile plurality of fire sensor poles is positioned on autonomous vehicles. In one embodiment, the first and second pluralities of the fire suppression drones are unmanned aerial vehicles. In another embodiment, the first and second plurality of fire suppression drones include data sensors configured to gather wind speed and direction data, and temperature data, wherein the data sensors are connected to the metropolitan area network. In yet another embodiment, tethering lines are provided, wherein the tethering lines are configured to attach to the unmanned aerial vehicles in high wind conditions. In one embodiment, the data sensors are further configured to capture ember and flame images.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 illustrates a system and method for fire suppression via artificial intelligence according to an embodiment of the present invention;

FIG. 2 illustrates an alternative mean of controlling a fire suppression drone according to an embodiment of the present invention;

FIG. 3 illustrates a tethering system in high wind conditions according to an embodiment of the present invention;

FIG. 4 illustrates a movable sensor pole according to an embodiment of the present invention;

FIG. 5 illustrates an alternative fire suppression means according to an embodiment of the present invention;

FIG. 6 is a flow diagram illustrating a method for fire suppression via artificial intelligence according to an embodiment of the present invention;

FIG. 7 illustrating a system and method for fire suppression via artificial intelligence according to an embodiment of the present invention;

FIG. 8A-B illustrate an exemplary method for fire suppression via artificial intelligence according to an embodiment of the present invention; and,

FIG. 9 illustrates an exemplary fire condition according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system and method for fire suppression via artificial intelligence.

The word “a” is defined to mean “at least one.” The words “firefighting” or “fire suppression” may be used interchangeably. The word “wildfire” is defined as “a large, destructive fire that begins outside the home and spreads quickly over woodland or brush, typically aided in spread by dry, hot and windy conditions.” The word “algorithm” is defined as “a set of rules given to an artificial intelligence program to help it learn on its own,” The words “machine learning” are defined as “an application of artificial intelligence that provides system the ability to automatically learn and improve from experience without being explicitly programmed.” The words “artificial intelligence” or “AI” are a general term recognized to have a variety of definitions. Such definitional variations often reflect variations in scope and fields of application of the so-defined AI. For many scientists however, AI refers to an ‘intelligent machine’ which demonstrates said machine intelligence via machine's behavior as similar to the intelligent behavior displayed by a human or other animal. This definition applies to a machine, for example, in its understanding of human speech, to machines competing successfully in games such as chess or Go, machine driving of autonomous cars, machine intelligent routing of goods within a content delivery system and machine making intelligent decisions in military simulations. For the purposes of this formal application therefore, “AI” is defined as “the ability of intelligent agents via the present invention to suppress fire, which is further defined as any device that both perceives wildfire within its environment and takes action, at least semi-independently, where said action tends to fight or prevent spread of, or damage from the wildfire.” The terminology includes the words above specifically mentioned, derivatives thereof, and words of similar import.

It is noteworthy, that in defining AI for the public or those speaking colloquially, the term AI is often applied whenever a machine appears to mimic learning or problem solving. However, over time such a definition has been subjected to limitation when, to the public, a machine-performed task becomes familiar to the public, and hence less ‘machine-like’. For example, optical character recognition is a form of AI, yet many in the public would exclude it from AI apparently due to its familiar place in daily life. This narrowing of AI in definition by the public has led some to quip that AI is ‘whatever hasn't been done yet’ by a machine.

Similarly, for some in computer science, the term AI is judged not so much on the degree of intelligent agency or uniqueness of that activity, but more on the specific tools utilized or goals designated. Under such approaches, typical tools qualifying for AI category include neural networks, versions of search and mathematical optimization and the like.

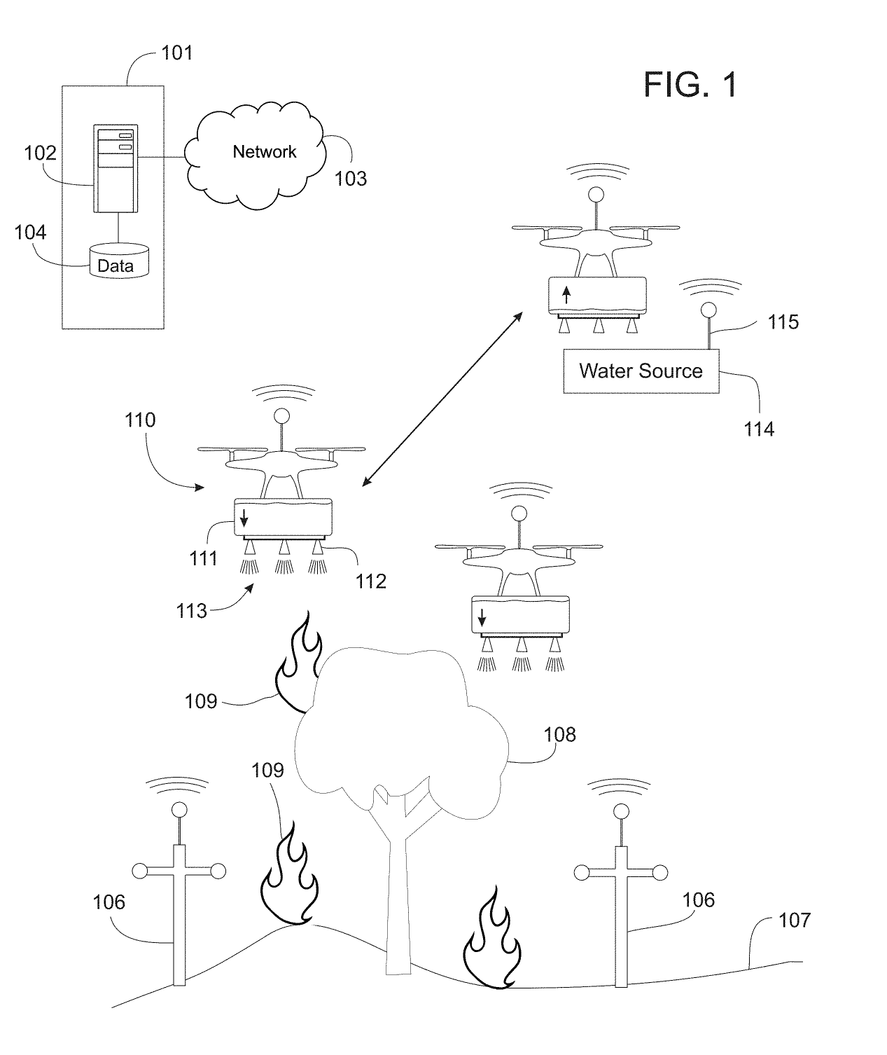

FIG. 1 illustrates a system and method for fire suppression via artificial intelligence according to an embodiment of the present invention. Referring to FIG. 1, the system comprises an AI enabled computer command system 101 configured to carry out the method of the present invention. In one embodiment, the AI enabled computer command system includes an Internet connected server 102 having an operating system, applications, CPU, keyboard, display, and any other computer component as well known in the art. The internet connected server is connected to a data repository 104, which may be any kind of data storage as known in the art, including local and/or cloud based. In one embodiment, the Internet connected server is connected to a network 103, wherein the network may be a wide area network (WAN), a local area network (LAN), and/or a metropolitan area network (MAN). Preferably, the network is a wide area network that includes several metropolitan area networks, wherein each city or community is represented by a metropolitan area network. In this regard, the data gained during the method is processed by machine learning algorithms to improve future decisions carried out by the AI enabled computer command system. The details of the AI enabled computer command system will be described in greater detail below.

In one embodiment, fire sensor poles 106 are placed in terrain 107, typically in and surrounding community/metropolitan areas defined in a MAN network. In one embodiment, the fire sensor poles are constructed from fire-resistant or fire-proof materials and include an antenna that is in wireless communication with the AI enabled computer command system via the MAN network. In one embodiment, the fire sensor poles include sensors configured to gather wind speed and direction data, as well as temperature data. In some embodiments, a 360 degree enabled camera device is provided to record video and audio data in the area surrounding the fire sensor poles. Preferably, these poles are scattered strategically in the protected desired area, i.e. community/metropolitan area. The size, shape, and appearance of the fire sensor poles may vary. For instance, the fire sensor poles may not resemble poles and can be blended into the environment, however regardless of the size, shape, and appearance the data sensors provided must be able to operate in extreme conditions, including but not limited to high temperatures and high wind conditions. Each fire sensor pole can monitor a predetermined area, thus a predetermined number of fire sensor poles are required depending on the land area size that is required to be monitored.

Still referring to FIG. 1, when that data captured via a fire sensor pole indicate that a fire 109 may be present e.g. a hot spot or elevated temperature, the AI enabled computer command system communicates with a fire suppression drone 110 the location of the possible fire. in one embodiment, the drone includes a reservoir 111 configured to store a fire-suppression substance and a nozzle 112 configured to release the fire-suppression substance, wherein the fire-suppression substance is water or water mixed with a fire retardant. In alternative embodiments, the fire-suppression substance is a fire retardant foam or gel. In one embodiment, the communication to the drone is via an Internet enabled wireless antenna in communication with network 103. Once the drone arrives at the location of the fire, the fire-suppression substance is released 113 on the fire. Next, the drone is sent to the closest water source 114 such that the reservoir may be resupplied. In one embodiment, the drone includes a pump configured to pump up the fire-suppression substance into the reservoir. In alternative embodiments, the pump is located in or adjacent to the water source. In some embodiments, the water source is the fire-suppression substance, e.g. water mixed with a fire retardant. In one embodiment, an Internet enabled wireless antenna 115 in communication with network 103 is positioned on or adjacent to the water source. The antenna communicates the current location with the drone via AI enabled computer command system, which is particularly useful if the water source is mobile. For instance the water source may be located in a vehicle, such as a pickup truck or fire truck, or may be a stationary natural water source such as a lake or river. It is a particular advantage that the drone travels directly to the water source after releasing the fire-suppression substance regardless of whether or not the fire was extinguished so that the drone can be ready when needed. The AI enabled computer command system via fire sensor pole data determines whether or not the fire was extinguished, and if not the drone is instructed to travel back to the fire location to repeat the previous steps. One can appreciate that a plurality of drones are likely dispersed in the above example, such that fire-suppression substances can be continually released to suppress the fire. Although the drone illustrated is an unmanned aerial vehicle (UAV), the drone may he a land based vehicle in some embodiments. However, the UAV drone is particular useful as UAVs can transverse land area quickly and access elevated heights such as treetops 108 or skyscrapers. The basic components of the system have been described above, however the AI enabled computer command system with machine learning capabilities are particular useful for fighting fires. This will be described in further detail below.

The present invention, in order for its method and system to enable its computer-AI to make decisions in a human-like manner of logic, enables in its development process a method which goes beyond Repetitive Process Automation (RPA). Whereas RPA works well for automating simple repetitive tasks done by humans, RPA is typically unable to automate complex human-centric tasks.

Such complex tasks require human-like reasoning and intelligence to be efficiently handled. Because machine learning is data intensive, the computer applications of AI too often simply copy WHAT people do, but do not consider the drivers and reasoning that led to said human behavior.

The present invention accounts for human-reasoning-input by capturing, in an ongoing manner, via recording reasoning steps, related data from fire-fighting professionals as they carry out the tasks. Thus the WHY of fire-fighting decisions by humans is relatable in data format from the individual humans carrying out the task of fire detection, planning to fight, and actions of fire-fighting. These human-derived factors are data then used to enable programming algorithms within the present invention Al functionality.

To verify performance, human monitoring in real time permits adjustment of system performance. Present invention computer system thus learns to perform tasks enabled by a human-reasoning informed setting. Such ‘Behavioral AI’ uses a cognitive architecture to represent WHY and HOW people behave, the human reasons behind making decisions.

To summarize, the present invention method and system captures as data the cognitive decision process and reasoning which fire-fighting people go through when performing the real life tests or tasks of fire-fighting on the terrain of the test herein disclosed. This reasoning data-set enables codifying said function into automation software algorithms of reasoning, which allows for transparent, robust and effective automation of human-centric tasks within the present invention.

In one embodiment, the method and system is designed by fine tuning of software programming as used on state of the art computer hardware, based on data gathered while connected to tire sensor poles as outlined below on test scenarios in the real physical world of fire-fighting.

The present invention AI enabled computer system is trained in the well-known art and manner of AI programming development and implementation, comprising trial and error, based on pre-set goals and parameters, as adjusted from time to time by human programmers.

In the present invention, the system and method utilize such AI programming development during and associated with physical world fire-fighting on a test field, and undertaken so as to produce activity by the AI controlled system which via training at least partly mimics human actions in fire-fighting.

For example, in data-observed missions in tests over physical test terrain, multiple scenarios for test fires are conducted. During these test fires, the AI enabled computer system and method is developed, and in so doing will generally comprise components in 4 categories: (a) communications; (b) data/data handling; (c) physical fire-fighting equipment; and (d) supplies.

The system and method is enabled via a training phase which precedes an operational phase. The training phase of the system and method enablement occurs in a controlled test environment, such as on an island with set conditions of fire placement, wind conditions and the like.

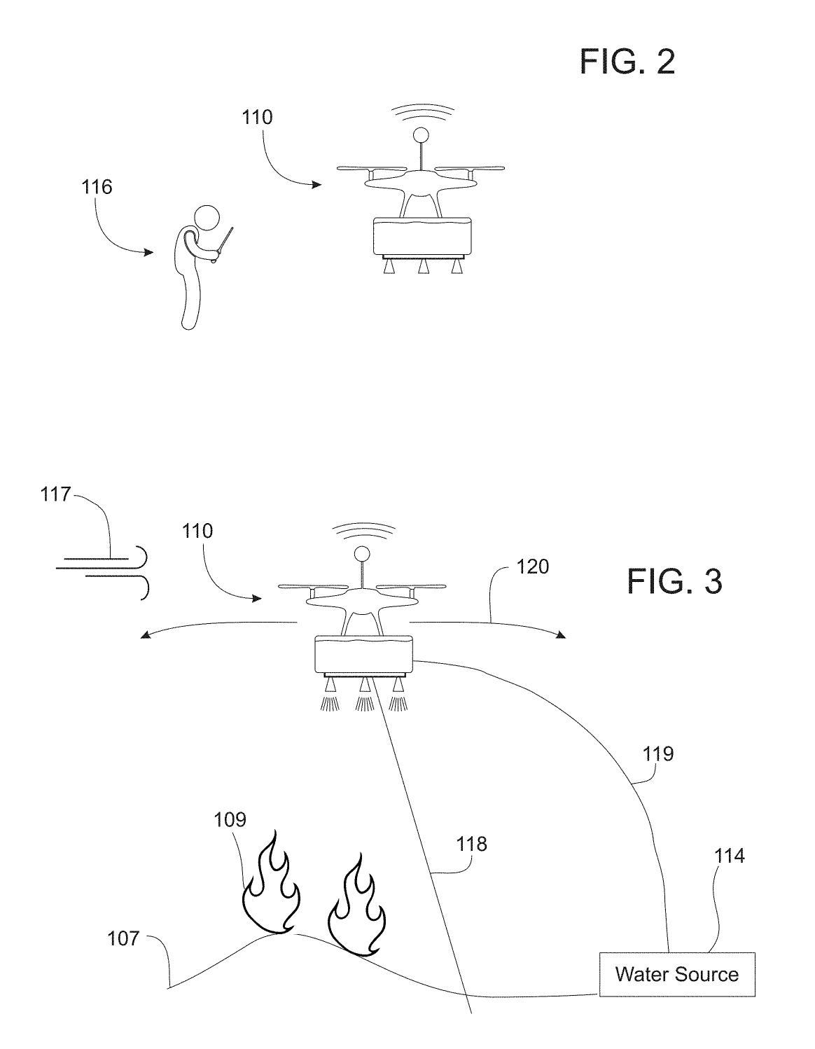

The training phase comprises multiple scenarios, typically of stepwise increasing complexity, and each of which is divided into two parts, a first part wherein humans 116 (FIG. 2) control the equipment and cause the equipment to respond to the scenario with professional fire-fighting alacrity and function.

Thus, data is gathered by sensors of the computers, whereby such data includes the activities enabled by the human fire-fighters. Thus when humans face the test, they respond logically and swiftly, and employ their eyes and ears to view the problem, design a response, undertake to execute that response, and adjust as needed.

Meanwhile, the AI enabled computer system gathers the data of such test and the human response. Then the same test is repeated for the AI enabled computer system to execute the response.

This is followed by an evaluation pause while the data is analyzed and appropriate adjustments to programming are made for needs of method and system to mount improved independent response.

Then, where said AI response is judged adequate, the second test is undertaken. In this manner, each part of each stepwise more complex test comprises a modification of equipment, administering of the supplies, compiling and using data, verifying communications and so forth, in order to execute an improved repeat handling of the test, moving from semi-autonomous mode, then to fully autonomous mode. Using this learning pattern to build experience, and compile a background dataset, a progressively more complex training phase is undertaken by the AI enabled computer system, with corrective action administered via programming fine tuning and equipment adjustment as needed.

To fight a fire per the present invention, as previously mentioned the drones are preferably unmanned aerial vehicles (UAVs). In one embodiment, the UAVs are constructed of a special design. The special design includes heat-resistant material, such as having electronics protected from damage by adding heat shield material similar to the NASA heat shield blanket. As previously mentioned, the UAVs have refillable reservoirs to store fire-suppression substances. In alternative embodiments, the UAVs may include low-frequency-sound generation components to suppress flames similar to DARPA testing results, as well known in the art.

The reservoirs for water are associated for use with water sources. As previously mentioned these can be stationary, e.g. lakes, rivers, or mobile. For example, in one embodiment, mobile water sources may be trucks carrying coordinated supply tanks of water such that the UAVs are enabled to visit and refill as needed and directed via the AI enabled computer command system.

In alternative embodiments, drones may include autonomous vehicles of a bull-dozer design with a nozzle for water spray dispatch mounted on a crane that telescopes to height for further water dispersing at a distance. It is critical to note, that not only the vehicle is autonomous, each piece of equipment is also autonomous, and subject to sensors which alert computer control of local circumstances of each vehicle. If a vehicle is in an area of extreme heat such that the vehicle heat sensor reports a temperature approaching a level known to exceed the working tolerances of the vehicle, the computer software sends a message to the close-to-overheating vehicle to execute a command designed to protect/remove the vehicle from the heat danger.

The coding parameters of AI used by the present invention computer command system place a high value on preservation of equipment in working order. Thus, a refill signal is sent to UAV where the sensor, such as reservoir fill amount, indicates a need to refill. Similarly, the data available to the computer command system includes terrain geography and topography. Thus, a tracked bull-dozer (TBD) vehicle will be routed along roadways known to the system, in a manner of routing which keeps the TBD close to the spreading fire for purposes of fighting fire by spray of water and clearing road for water-supply-vehicle (WSV), while sufficiently stable and mobile along a path of terrain not exceeding the road specs of travel for TBD or WSV.

While speed of putting out detected flames is a key goal of the AI, similarly the continued operability of equipment is critical. A sample test layout would include a square ten acre area of scrub land with areas of sandy land, grass land, tree land and the like. Within this test area, multiple gas-fed burners of various sizes are dispersed, as well as a layout of roads. In a test, five burners are lit by remote-control fire-starter. These fires burn continuously, and the detection capability of the aerial sensors to detect and pinpoint the burning flames is recorded. An alarm is sent to humans and recorded as data on computer files. Data of each fire location is recorded. A human plan is prepared and executed using equipment operable in manual, semi-automated or fully automated format. The response of the human operators is recorded in each vehicle, such as dispatch of WSV, filling of UAVs, dispatch of UAVs, filling and dispatch of TBD and the like. The data regarding success of putting out fires among the five test fires is recorded, including which the humans chose to put out with UAVs, presumably due to remoteness from roads, and which the humans chose to put out with TBDs, presumably due to size of fire or nearness to road.

Following the human-performed mission, the data of sensors onboard the vehicles is analyzed to verify operation. Where operability is satisfactory to proceed, the situation is re-set, the same five fires are then lit, and the humans ride in the TBD and observe the UAV and WSV activity, but make only such adjustments as safety and operations require while computerized AI control proceeds to undertake the same mission to extinguish said fires. Optionally, an area of flames is excessive for close UAV approach, and data so signals. Wherein, humans will respond by dispatching TBD and WSV along roads nearby, or by creating a new road as needed using TBD. After such mission, a mirror-mission, in a new area is performed by AI enabled computer system, as the road will need to be newly formed in scrub land, not using the human-created road of earlier test.

FIG. 3 illustrates a tethering system in high wind conditions according to an embodiment of the present invention. Referring now to FIG. 3, in high wind conditions 117, the fire suppression drone, e.g. UAV 110 may be tethered 118 to the terrain 107 enabling the ability to maintain position in the strong wind, while still having the ability to maneuver sufficiently to release fire suppression substances as previously mentioned. In operation, the UAV is deployed upwind from fire 109, and preferably the fire front or the leading edge of the fire perimeter. In one embodiment, data collected via from sensors either from the UAV and/or fire sensor poles, and as analyzed using algorithms, the fire front location, and the wind direction enables the Al computer command system to determine the optimum location for tethered operations to suppress fire spread.

In one embodiment, the tether may be connected and anchored to a ground-vehicle. Preferably, the tether anchor is placed at or near a point on the terrain outside the active fire front area. In one embodiment, the UAV includes a supply line 119 connected from a water source 114 directly to the reservoir of the UAV. As previously mentioned, the water source may be a stationary source or a mobile source; further, the water source may include alternative suppression substances, particularly when the water source is not natural. For example, in one embodiment, the water source is a tanker vehicle loaded with a fire suppression substance. It is a particular advantage of the present invention that the supply of the fire suppression substance is automatic based on refill signals.

During operation, ideally, the UAV flies a curved arc 120 on the tether line, wherein the line is either a fixed or alternative length, e.g. a reel is provided. A variable length tether line enables the UAV to descend near the fire front to administer a dose of suppressant, and then upwards to avoid overheating by the extreme temperatures.

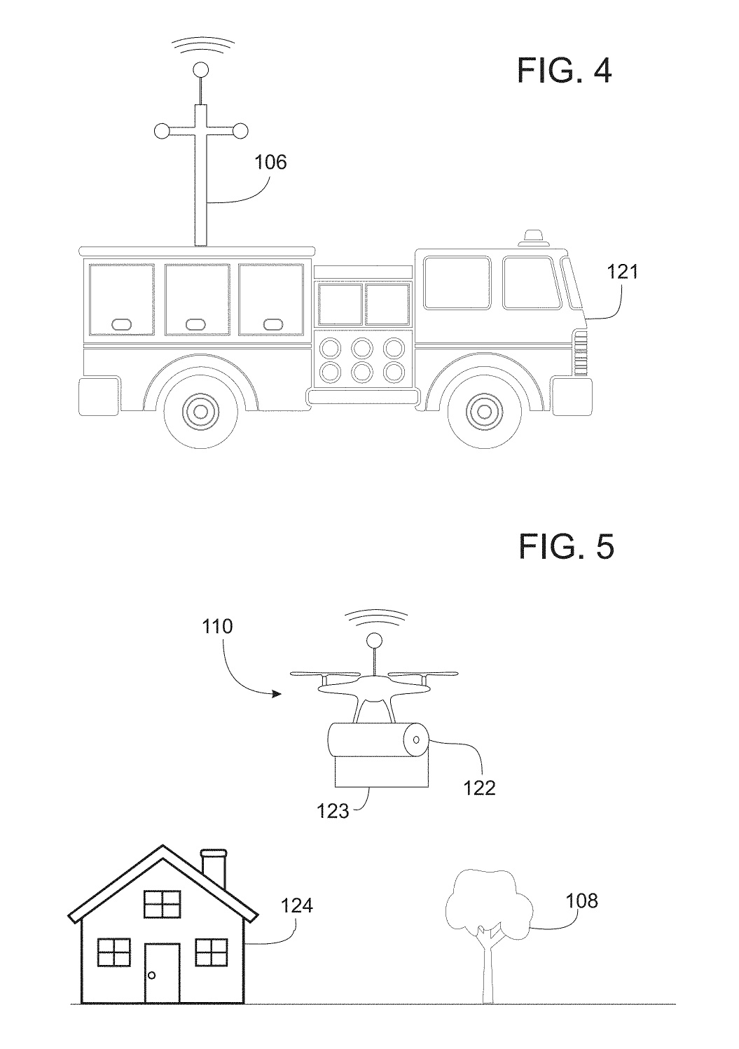

Referring now to FIG. 4, a fire sensor pole 106 may be positioned on an autonomous vehicle 121, wherein the autonomous vehicle is controlled by the AI-enabled computer command system. For the sake of this disclosure, any fire sensor pole previously discussed or discussed below may be stationary or mobile. A further advantage of mobile AI enabled fire sensor poles is that they can also function as a fire warning system in communities. For instance, prior to a formal warning from a fire department, these mobile sensor poles are sent out to locations and can detect smoke, embers, temperature, wind direction, and intensity providing a visual warning to the community based on its appearance that the citizens in the specific community may be in a high risk area based on current conditions. In one embodiment, autonomous flatbed trucks and UAVs include fire suppression blankets that may be dispatched to these homes in the high risk community, particularly homes located downwind from an approaching fire. This will be discussed in greater detail below.

Referring now to FIG. 5, in some embodiments, drones such as UAVs 110 may include a fire suppression blanket 123 typically provided on a reel 122. Ideally, UAVs equipped with a fire suppression blanket are used in conjunction with fire suppression substance reservoir filled UAVs, as fire suppression blankets are very useful as a preventive measure for homes 124 and trees 108. The method of using such equipment will be discussed in greater detail below.

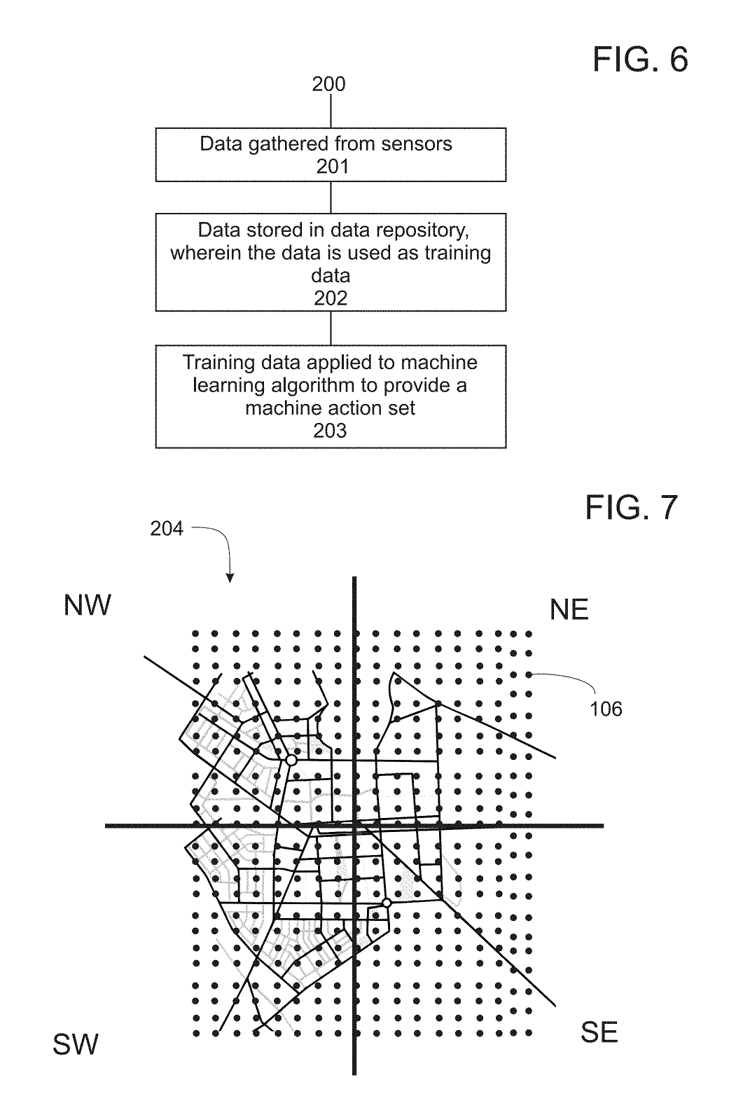

FIGS. 6-8 illustrate an exemplary method for fire suppression via artificial intelligence according to an exemplary embodiment of the present invention. Referring now to FIG. 6, a method 200 includes step 201, data gathered from sensors. In one embodiment, the data is training data referring to datasets gathered from sensors disposed on terrain wherein fire approached in past, such data linked to map coordinates of said earlier fire event. In step 202, the datasets are stored in a data repository and serve as training data wherein fire-fighting by similar drones were successful in suppressing the past earlier fire. In step 203, the machine learning algorithm uses said training datasets to match to ongoing input data sets from simulations to form a machine action set of instructions to drones. The machine action set is modelled in computer as simulated response to simulated fire approach, and results are viewable such as how many drones are routed to which sector of the map to fight fire. The machine learning algorithm provides an initial prediction to ‘success’ as defined as correct routing of drones to proper locations such as hotspots of fire approaching. Where incorrect routing is noted, the corrective nature of machine learning intervenes. In this case, the machine is prompted to replay the data simulation with instruction to route drones mostly to simulated hotspots. The prompting can be via human intervention, as in supervised machine learning, or by machine self-prompting, as in machine-self-correcting. A combination of such means is also envisioned.

Referring now to FIG. 7, an exemplary map 204 comprising a north west (NW), north east (NE), south west (SW), and south east (SE) quadrants. The map defines a community or predetermined area wherein method and system is utilized. The map includes a plurality of indicators dots representing a plurality of fire sensor poles 106. The map is a visual representation of the map coordinates in which the AI enabled computer command system receives data gathered from the plurality of fire sensor poles, and based on the data sends drones to specific coordinates.

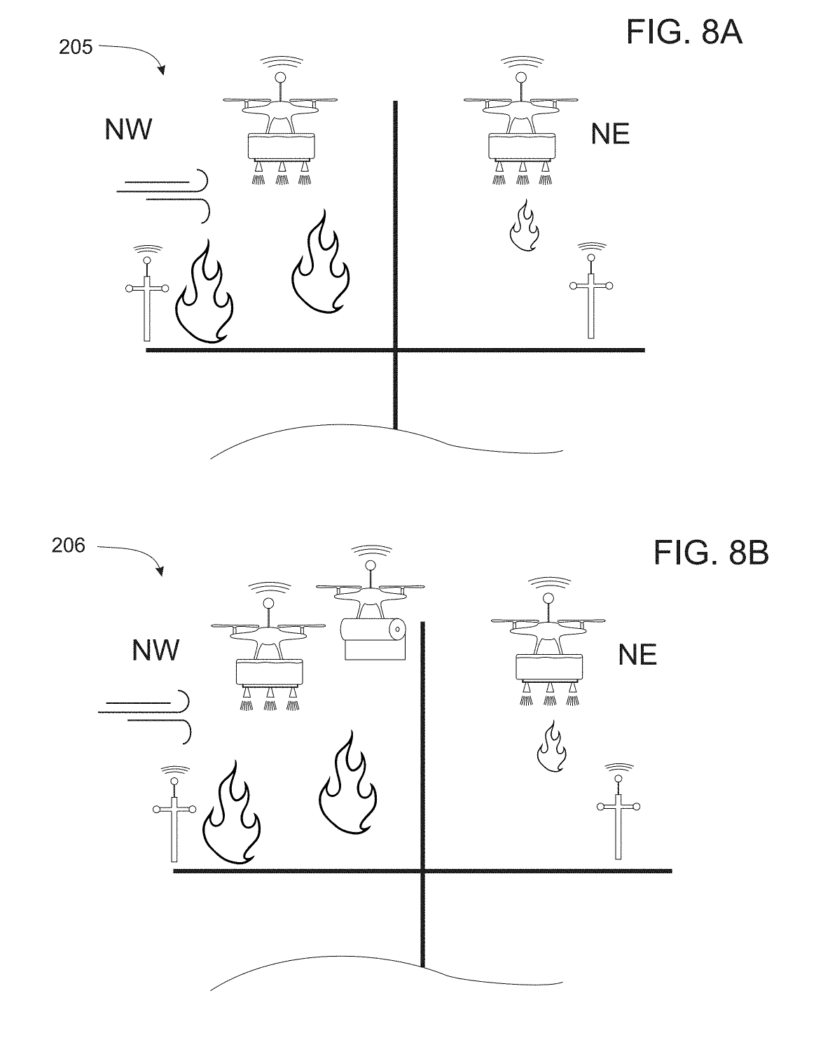

Referring now to FIG. 8A-B, an exemplary scenario will he described. In this scenario, a fire is approaching the community from the north. Wind and terrain combine so the fire becomes more severe in the NW, less severe in the NE. Drones, preferably UAVs, in both NW and NE via AI-linked sensors are sensing hot/bright spots. Drones in NW and in NE are autonomously spraying fire suppression substances on the hot/bright spots via AI (205; FIG. 8A). However, NW UAV sensors alert AI to learn that hot/bright spots in NW are relatively less extinguished and the UAVs in NE allow central AI algorithm to learn hot/bright spots in NE more extinguished. The AI enabled computer command system, noting this pattern, reacts and assigns more home protection UAVs equipped with fire suppression blankets to NW (206; FIG. 8B). UAVs thus instructed to deliver fire suppression blankets to more NW homes/fewer NE homes.

The previous example is just one exemplary scenario that may occur. It is a particular advantage of the present invention to protect homes that may be at high risk for fire damage. This is particularly true for spot fires. Spot fires happen when embers spread in the wind from an upwind fire, as well known in the art. The drones and fire sensor poles, movable and stationary, are able to gather data of spot fires in the community. The danger with spot fires is the possible rapid growth, particularly in vicinity to homes, as they may burn and grow on lawns and/or roofs. Consequently, the present invention provides a means to extinguish spot fires when homeowners and fire-fighters are not present. This is an addition to the previously described method for suppressing a wildfire front. Thus, the method provides fire blankets for homes in high-risk community areas, whereas mid-risk homes get assigned UAV to fight roof or nearby spot-fires; such is coordinated per range finders on UAV/GPS function for UAVs.

In a preferred embodiment, the present invention includes an algorithm for estimating fire-risk for each subscribing home in the protected community. The applied risk rating and modalities of protection, optionally comprise terms reflecting elements of a Fire Behavior Triangle. For example, local data specific to topography is derived from measurements of terrain of the community and the like, and such is fed into the algorithm for use as appropriate. Each home's fire risk is thus adjusted for predicted protection or predicted elevated fire-risk afforded by said home's location, adjusted by factors such as site slope, aspect, elevation, and relevant adjacent landscape features like narrow and wide canyons, ridges, and saddles. In a preferred embodiment, said algorithm for risk rating for subscribing homes is further similarly and optionally comprised of terms reflecting the mathematical influence on fire-risk on each home by nearness and home site-relevance in terms of direction of approaching wildfire by community local features of geography such as rock outcroppings, streams, rivers, lakes, and roads, which may sometimes act as fire barriers at least from a specific direction of approach of wildfire.

The other two elements of the classic Fire Behavior Triangle beyond topography (weather and vegetation fuel) also are optionally, in a preferred embodiment, utilized in algorithm and comprise fire-risk assessment for specifics related to each subscriber home. For example, weather, while the most variable element in terms of changes day to day or day to night, typically affects all homes of a small community in roughly equal measure, being a wide area effect. Thus a hot, dry, windy summer raises the risk rating of all homes. Meanwhile vegetation influence is much more localized, depending on the specific location of each home. In a preferred embodiment, built up dry vegetation is assessed in the community and nearby environs. Then data of such buildup, by reference to location versus each home site, such as pine needle build up or accumulation of dried fallen branches, is made available for use and accounted for in an algorithm. Where such data is provided reliably and used wisely in algorithm analysis, fire-risk assessment can be improved home by home. Typically, homes close vegetation build up, especially in upwind locations of the fuel vegetation build up, have an increased fire-risk rating. Furthermore, in a preferred embodiment, as part of the advice the algorithm optionally specifies to a community, are details of beneficial clean-up targets within the community to be carried out prior to a fire season, which clean-up can be reflected in reduced fire risk, at least for nearby homes.

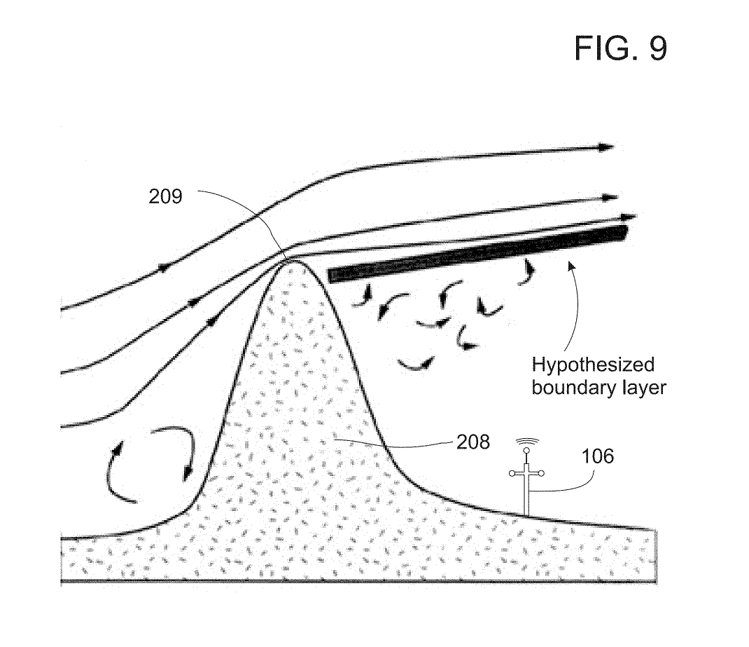

Referring now to FIG. 9, yet another particular advantage of the present invention is a method to predict and suppress fire conditions spreading via turbulent atmospheric boundary layer motions. Specifically, air flow across small elevation of land 208 leads to lee-side turbulence, thus traditional methods of fire prediction are not useful. However, the system and method of the present invention describes positioning fire sensor poles 106 in predetermined locations to capture the real time data needed to predict via algorithm these turbulence inducing areas of terrain. In addition to the actual turbulence identification, the fire sensor poles also measure air temperature and capture sensor images passing embers and images of flames approaching in grass or flames at tree-tops. Thus, the present invention fire sensor poles can predict if this particular ridgeline 209, at a particular and specific real time moment, is blocking a fire from advancing towards homes, or if the risk to the downwind homes is high.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention

Reference to “first,” “second,” “third,” and etc. members throughout the disclosure (and in particular, claims) are not used to show a serial or numerical limitation but instead are used to distinguish or identify the various members of the group.

What is claimed is:

1. A method for fire suppression via artificial intelligence comprising steps:
(a) collecting, via one or more sensors, a first dataset from a first location;
(b) analyzing, via an artificial intelligence enabled computer command system, the first dataset from the first location at a first time;
(c) identifying, via the artificial intelligence enabled computer command system, the first location as having a likely wildfire when the analysis at the first time sufficiently via an algorithm matches data in a data repository representative of an active wildfire;
(d) dispatching, via the artificial intelligence enabled computer command system, a fire suppression drone having onboard sensors and a reservoir configured to release a fire suppression substance to the first location at a second time;
(e) releasing, via the artificial intelligence enabled computer command system, the fire suppression substance on the likely wildfire;
(e) collecting, via the onboard sensors, a second dataset from the first location;
(f) analyzing, via the artificial intelligence enabled computer command system, the second dataset at a third time; and,
(g) identifying, via the artificial intelligence enabled computer command system, the first location as having at least a partially suppressed wildfire when the analysis at the third time sufficiently via the algorithm matches data in the data repository representative of a partially suppressed wildfire.

2. The method for fire suppression via artificial intelligence of claim 1, wherein the one or more sensors are provided on one or more fire sensor poles.

3. The method for fire suppression via artificial intelligence of claim 2, wherein the one or more fire sensor poles are positioned stationary in predetermined locations in a community.

4. The method for fire suppression via artificial intelligence of claim 2, wherein the one or more fire sensor poles are positioned on one or more autonomous vehicles.

5. The method for fire suppression via artificial intelligence of claim 1, further comprising a step (h) wherein the fire suppression drone travels to a reservoir refilling source to refill the reservoir.

6. The method for fire suppression via artificial intelligence of claim 5, further comprising a step wherein steps (d)-(h) are repeated until the partially suppressed wildfire is extinguished.

7. The method for fire suppression via artificial intelligence of claim 3, wherein the artificial intelligence enabled computer command system and the one or more sensors are connected to a metropolitan area network.

8. The method for fire suppression via artificial intelligence of claim 1, wherein the fire suppression drone is an unmanned aerial vehicle.

9. The method for fire suppression via artificial intelligence of claim 8, further comprising a step wherein the unmanned aerial vehicle is tethered to a ground surface in high wind conditions.

10. A method for fire suppression via artificial intelligence comprising steps:
(a) assessing a wildfire via an artificial intelligence algorithm;
(b) providing a set of fire-fighting instructions;
(c) executing the set of fire-fighting instructions, wherein the set of fire-fighting instructions comprises unmanned aerial vehicle enabled fire suppression techniques.

11. The method for fire suppression via artificial intelligence of claim 11, wherein the unmanned aerial vehicle enabled fire suppression techniques include a fire suppression substance released on the wildfire.

12. The method for fire suppression via artificial intelligence of claim 11, wherein the unmanned aerial vehicle enabled fire suppression techniques include tethering the unmanned aerial vehicle to a ground surface in high wind conditions.

13. The method for fire suppression via artificial intelligence of claim 11, wherein the unmanned aerial vehicle enabled fire suppression techniques include a fire suppression substance released on a spot fire spread from the wildfire.

14. The method for fire suppression via artificial intelligence of claim 13, wherein the unmanned aerial vehicle enabled fire suppression techniques include a fire suppression blanket released on homes adjacent to the spot fire.

15. A system for fire suppression via artificial intelligence comprising:
an artificial intelligence enabled computer command system including an Internet connected server connected to a data repository configured to run machine learning applications, wherein the Internet connected server is connected to a metropolitan area network defining a community;
a plurality of fire sensor poles positioned at predetermined locations in the community, wherein the plurality of fire sensor poles include sensors configured to gather wind speed and direction data, and temperature data, wherein the sensors are connected to the metropolitan area network;
a first plurality of fire suppression drones, each drone of the first plurality of fire suppression drones comprising a reservoir configured to store a fire-suppression substance, a nozzle configured to release the fire-suppression substance, and an Internet enabled wireless antenna in communication with metropolitan area network;
a plurality of fire-suppression substance refill stations configured to resupply the reservoir of each drone of the first plurality of fire suppression drones with the fire-suppression substance via a pump and a supply line; and,
a second plurality of fire suppression drones, each drone of the second plurality of fire suppression drones comprising a fire suppression blanket provided on a reel.

16. The system for fire suppression via artificial intelligence of claim 15, wherein the plurality of fire sensor poles are stationary and mobile, and wherein the mobile plurality of fire sensor poles are positioned on autonomous vehicles.

17. The system for fire suppression via artificial intelligence of claim 15, wherein the first and second pluralities of the fire suppression drones are unmanned aerial vehicles.

18. The system for fire suppression via artificial intelligence of claim 17, wherein the first and second plurality of fire suppression drones include data sensors configured to gather wind speed and direction data, and temperature data, wherein the data sensors are connected to the metropolitan area network.

19. The system for fire suppression via artificial intelligence of claim 17, further comprising tethering lines configured to attach to the unmanned aerial vehicles in high wind conditions.

20. The system o fire suppression via artificial intelligence of claim 17, wherein the data sensors are further configured to capture ember and flame images.
